(19) United States
(12) Patent Application Publication
(10) Pub. No.: US 2026/0149981 A1
(43) Pub. Date: May 28, 2026

(54) LEVERAGING NETWORK-RELATED EVENT DATA TO AUGMENT/REPLACE CELL TOWER TIMING ADVANCE DATA

(71) Applicant: DISH Wireless L.L.C., Englewood, CO (US)

(72) Inventors: Oscar Leonardo Rodriguez Gomez, Littleton, CO (US); Omar Amaya-Gonzalez, Littleton, CO (US); David Ricardo Bentolila Sapiani, Littleton, CO (US)

(21) Appl. No.: 18/962,664

(22) Filed: Nov. 27, 2024

(51) Int. Cl. H04W 24/02; H04B 17/318; H04W 64/00

(52) U.S. Cl. CPC H04W 24/02; H04B 17/328; H04W 64/00

(57) ABSTRACT

Systems and methods for leveraging network-related event data to augment/replace cell tower timing advance data. Event data is received from a plurality of user devices using a cellular network. The event data is stored by the user devices in response to the identification of network-related events that have occurred while the user devices are communicating will cells of the cellular. A distance between each user device and the cells is determined for each network-related event based on the event data. A user device traffic map is then generated based on the determined distances between the plurality of user devices and the cells. Cell coverage of the cellular network can then be optimized based on the user device traffic map.

### BACKGROUND

Smart phones are being used more and more by more and more people. As the use of smart phones has increased, so too has the desire for more reliable, fast, and continuous transmission of content. In an effort to improve the content transmission, networks continue to improve with faster speeds and increased bandwidth. The advent and implementation of 5G technology has resulted in faster speeds and increased bandwidth, but with the drawback of needing more cells in the network to limit dead spaces. Unfortunately, determining where to add new cells can be more challenging due to potential interference and variations in the amount of traffic at any given time. It is with respect to these and other considerations that the embodiments described herein have been made.

### BRIEF SUMMARY

Embodiments are directed to systems and methods for leveraging network-related event data to augment/replace cell tower timing advance data. Event data is received from a plurality of user devices using a cellular network. The event data is stored by the user devices in response to the identification of network-related events that have occurred while the user devices are communicating will cells of the cellular. A distance between each user device and the cells is determined for each network-related event based on the event data. A user device traffic map is then generated based on the determined distances between the plurality of user devices and the cells. Cell coverage of the cellular network can then be optimized based on the user device traffic map.

The use of network-related event data provided by user devices to determine distances between user devices and network cells enables for a more accurate understanding of where user devices are located within a cellular network when using or accessing the cellular network and for comparing utilization of various radio and network vendors to one another.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified. For a better understanding of the present invention, reference will be made to the following Detailed Description, which is to be read in association with the accompanying drawings.

FIG. 1 illustrates a context diagram of an environment for leveraging network-related event data to augment or replace cell tower timing advance data in accordance with embodiments described herein.

FIG. 2 illustrates a logical flow diagram showing one embodiment of a process for monitoring and obtaining network-related event data in accordance with embodiments described herein.

FIG. 3 illustrates a logical flow diagram showing one embodiment of a process for using network-related event data to generate a user device traffic map for network optimization in accordance with embodiments described herein.

FIG. 4 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

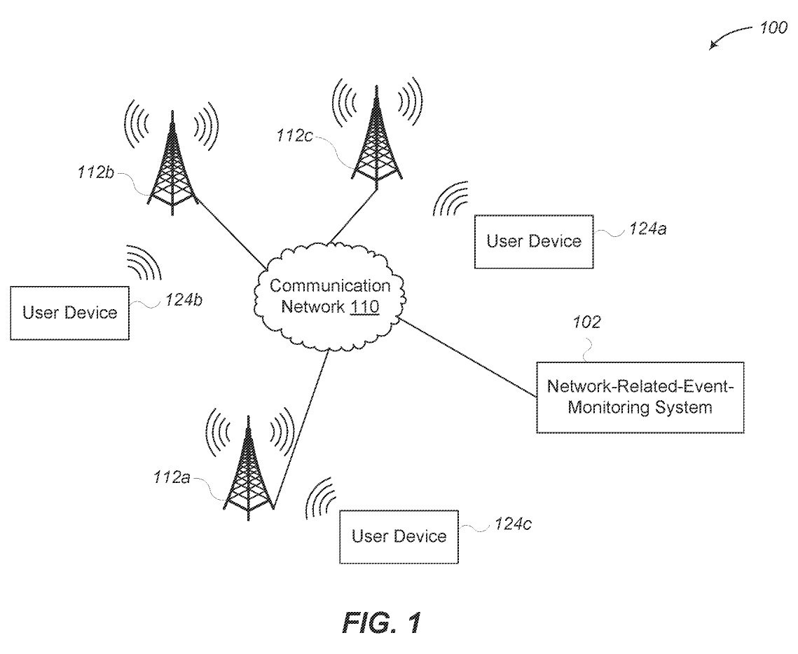

FIG. 1 illustrates a context diagram of an environment 100 for leveraging network-related event data to augment or replace cell tower timing advance data in accordance with embodiments described herein. Environment 100 includes a plurality of cells 112a-l12c, a plurality of user devices 124a-124c, a network-related-event-monitoring system 102, and a communication network 110.

The cells 112a-112c are cellular towers that together provide the hardware infrastructure of a cellular communications network, e.g., a 5G cellular communications network, which may also be referred to herein as a wireless network or a cellular network. The cells 112a-112c may include or be in communication with base stations, radio backhaul equipment, antennas, or other devices, which are not illustrated for ease of discussion. In various embodiments, the cells 112a-112c may communicate with each other via communication network 110. Communication network 110 includes one or more wired or wireless networks, which may include a series of smaller or private connected networks that carry information between the cells 112a-112c.

The user devices 124a-124c are computing devices that communicate with other computing devices via the cellular communications network comprising the cells 112a-112c. User devices 124a-124c may be referred to as user devices, mobile devices, mobile computing devices, user mobile devices, user equipment, or some combination thereof, or other similar terminology. Examples of user devices 124a-124c may include, but are not limited to, mobile phones, smartphones, tablets, cellular-enabled laptop computers, RedCap devices, Internet-of-Things devices, or other computing devices that can communicate with the cellular communications network. As one illustrative example, user devices 124a-124c may be mobile devices that are configured to receive and transmit cellular communications with the cells 112a-l12c.

In various embodiments, the user devices 124a-124c are configured to monitor interactions between the user devices 124a-124c and the cellular communications network for network-related events. As described herein, the network-related events may include the user device initiating a call, a call being dropped, the user device requesting to send or receive data, etc. In response to monitoring or detecting that a network-related event has occurred, the user devices 124a-124c are configured to store event data associated with that network-related event, including the cell 112 in which the user device is communicating at the time of the network-related event. The user devices 124a-124c can then provide the event data to the network-related-event-monitoring system 102. The network-related-event-monitoring system 102 is a server, computing device, cloud computing environment, or some other computing system configured to receive event data from user devices 124a-124c. As described herein, the network-related-event-monitoring system 102 can utilize the event data to determine the distance between the user device and a cell for each network-related event. These distances can be used to generate one or more user device traffic maps, which can be used to optimize the cellular communications network.

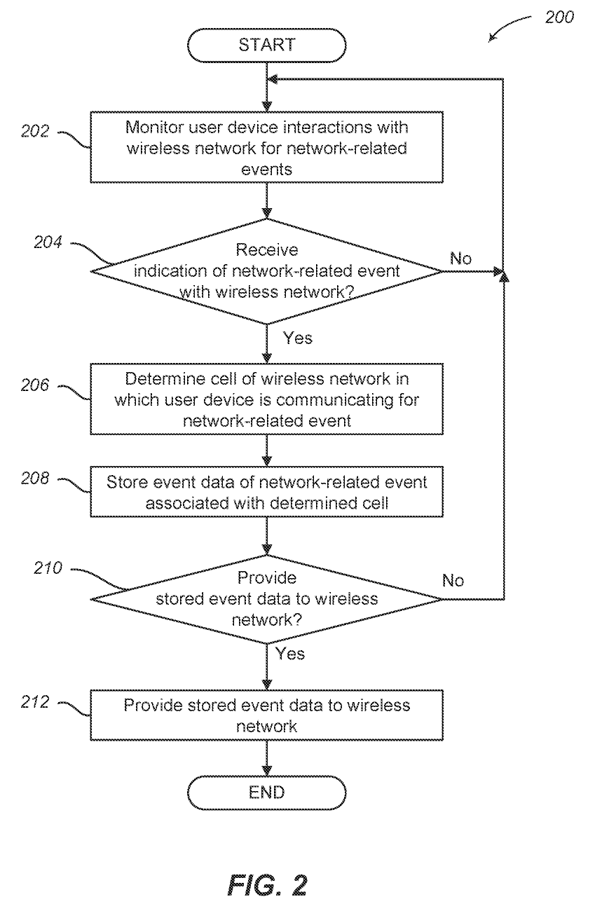

FIG. 2 illustrates a logical flow diagram showing one embodiment of a process 200 for monitoring and obtaining network-related event data in accordance with embodiments described herein. Process 200 may be implemented by one or more processors or executed via circuitry on one or more computing devices, such as user devices 124a-124c in FIG. 1.

Process 200 begins, after a start block, at block 202, where user device interactions with a wireless network are monitored for network-related events. Network-related events include actions or issues with respect to communications between the user device and the wireless network. For example, network-related events may include calls initiated by the user device (which are to be transmitted via the wireless network), calls through the wireless network that are dropped, requests to send data via the wireless network, requests to receive data via the wireless network, etc.

Process 200 proceeds, after block 202, to decision block 204, where a determination is made whether an indication of a network-related event with the wireless network has been received. An indication of a network-related event may be received in response to the user device detecting a network-related event with respect to the wireless network. In some embodiments, an indication of a network-related event is a flag indicating that a network-related event has occurred. In other embodiments, the indication of a network-related event may include information regarding the network-related event itself, such as the type of event, the geographical location of the user device at the time of the network-related event, the current signal level or signal quality (also referred to as a signal level/quality) with a cell of the wireless network, or other data identifying or detailing the network-related event. If an indication of a network-related event has been received, then process 200 flows to block 206; otherwise, process 200 loops to block 202 to continue to monitor user device interactions with the wireless network for network-related events.

At block 206, a cell of the wireless network in which the user device is communicating for the network-related event is determined. In various embodiments, an identifier of the cell is determined or obtained. In some embodiments, the cell may be queried for its identifier. In other embodiments, communications sent from the cell to the user device may include the identifier of the cell.

Process 200 continues, after block 206, at block 208, where event data of the network-related event is stored. In various embodiments, the user device stores logs of each network-related event, where each log includes the event data and the identifier of the cell in which the user device is communicating during or when the network-related event occurs. In various embodiments, the event data may include the type of event, the geographical location of the user device at the time of the network-related event, the current signal level or signal quality with a cell of the wireless network, the identifier of the cell, or other data identifying or detailing the network-related event, or some combination thereof.

Process 200 proceeds, after block 208, to decision block 210, where a determination is made whether the stored event data is to be provided to the wireless network. The user device can provide the stored event data to the wireless network at selected times, periodically, in response to storing a threshold amount of event data, in response to storing a threshold number of network-related events, in response to a request from the wireless network, or at some other time. If the stored event data is to be provided to the wireless network, then process 200 flows to block 212; otherwise, process 200 loops to block 202 to continue to monitor user device interactions with the wireless network for network-related events.

At block 212, the stored event data is provided to the wireless network. In various embodiments, the user device transmits the stored event data to the network-related-event-monitoring system 102 independent of or autonomous to the user of the user device or to other actions or communications being performed by the user device.

After block 212, process 200 terminates or otherwise returns to a calling process to perform other actions. In some embodiments, process 200 may loop (not illustrated) after block 212 to block 202 to continue to monitor user device interactions with the wireless network for network-related events. In this way, the user device can continuously obtain, store, and provide event data to the wireless network.

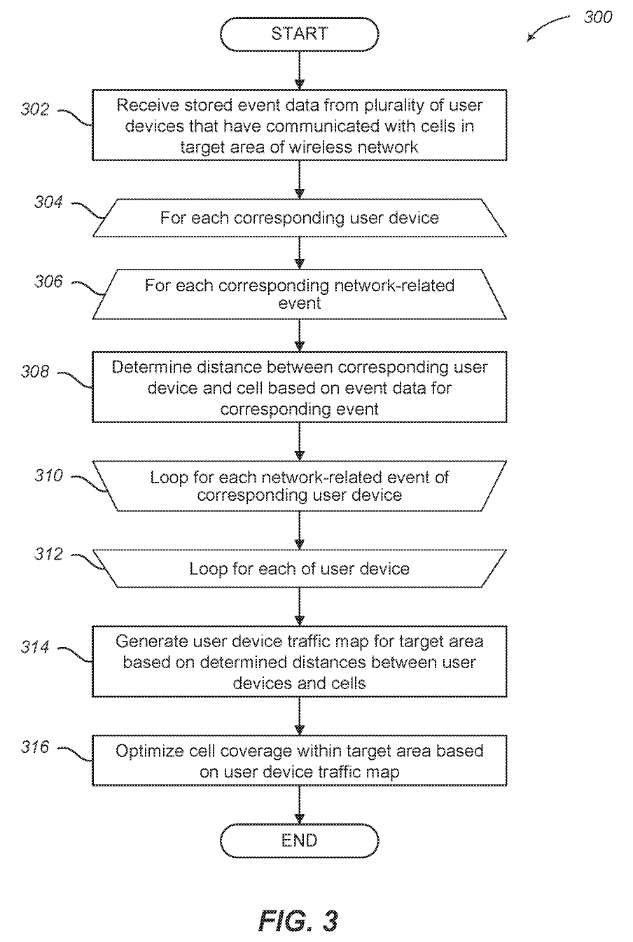

FIG. 3 illustrates a logical flow diagram showing one embodiment of a process 300 for using network-related event data to generate a user device traffic map for network optimization in accordance with embodiments described herein. Process 300 may be implemented by one or more processors or executed via circuitry on one or more computing devices, such as network-related-event monitoring system 102 in FIG. 1.

Process 300 begins, after a start block, at block 302, where stored event data is received from a plurality of user devices that have communicated with cells of a wireless network within a target area. As described herein, each user device may store event data in response to receiving an indication of a network-related event with the wireless network, and then provide that stored event data to the wireless network. In some embodiments, the target area may be for a city, town, market, neighborhood, county, or other geographical area of the wireless network. In other embodiments, the target area may be a group of a plurality of cells of the wireless network.

Process 300 proceeds, after block 302, to block 304, where each corresponding user device is selected to be processed from the plurality of user devices that provided event data to the wireless network.

Process 300 continues, after block 304, at block 306, where each corresponding network-related event is selected to be processed from the plurality of network-related events for the corresponding user device.

Process 300 proceeds, after block 306, to block 308, where a distance between the corresponding user device and the cell for the corresponding network-related event (i.e., the cell of the wireless network in which the corresponding user device was communicating with before, during, or at the time of the corresponding network-related event) is determined. In general, the use of the event data to determine the distances between user devices and cells when network-related events occur augments or replaces cell tower timing advance data.

The distance between the corresponding user device and the cell is determined by comparing the known geographical location of the cell and the geographical location of the user device before, during, or at the time of the corresponding network-related event (as obtained from the stored event data). In various embodiments, the distance between the corresponding user device and the cell may include a value indicating the linear space between the corresponding user device and the cell. In at least one embodiment, the distance between the corresponding user device and the cell may include a horizontal distance, a vertical distance, or a combination thereof.

In some embodiments, the distance may also include a direction from the cell to the corresponding user device. The direction may be a single compass heading/degree, a range of compass headings/degrees, cardinal or intercardinal directions, or other directional information from the cell to the corresponding user device. In some embodiments, the direction is determined by comparing the geographical location of the user device relative to the known geographical location of the cell. In other embodiments, the direction may be determined by the positioning and beamwidth of the cell.

Other information in the stored event data may also be used to determine the distance between the corresponding user device and the cell. For example, in some embodiments, the signal strength between the corresponding user device and cell may be utilized to estimate the distance between the corresponding user device and the cell. Estimating this distance may also take into account the type or hardware of antenna or radio of the corresponding user device or of the cell.

Process 300 continues, after block 308, at block 310, which loops to block 306 to process event data for each corresponding network-related event received from the corresponding user device.

After block 310 and a distance between the corresponding user device and a cell is determined for each corresponding network-related event received from the corresponding user device, process 300 proceeds to block 312. At block 312, process 300 loops to block 304 to process each corresponding user device of the plurality of user devices that provided event data at block 302.

After block 312, process 300 continues at block 314, where one or more user device traffic maps are generated for the target area based on the determined user device distances. In various embodiments, the user device traffic map is a heat map showing higher concentrations of user devices at specific distances and directions from one or more cells in the target area compared to lower concentrations of user devices for network-related events. In this way, the user device traffic map may show geographical areas within the target area where more user devices are associated with network-related events compared to other geographical area. In other words, the user device traffic map may be used to evaluate how many user devices (e.g., the percentage of user devices) are within certain distance ranges from the cells in the target area.

In some embodiments, a plurality of separate user device traffic maps may be generated, where each separate user device traffic map is for a different type of network-related event. For example, one user device traffic map may show concentrations of user devices initiating calls via the wireless network, and another user device traffic map may show concentrations of user devices requesting to send or receive data via the wireless network. As yet another example, one user device traffic map may show concentrations of user devices having a signal strength of a specific value or range, and another user device traffic map may show concentrations of user devices experiencing dropped calls.

Process 300 proceeds, after block 314, to block 316, where cell coverage within the target area is optimized based on the user device traffic map. In some embodiments, one or more machine learning or artificial intelligence trained models may be employed to identify locations in the target area in which to add a new cell to the wireless network, to select a change in a tilt of an antenna of at least one cell in the target area, to select a change in a transmission power of an antenna of at least one cell in the target area, or some combination thereof.

In some embodiments, the one or more user device traffic maps may be stored and compared to other user device traffic maps. These other user device traffic maps may be generated at a later time or by a different radio or network vendors or via some other process, which allows for comparisons over time or between vendors.

After block 316, process 300 terminates or otherwise returns to a calling process to perform other actions. In some embodiments, process 300 may loop (not illustrated) after block 316 to block 302 to continue to receive event data from user devices. In this way, the wireless network can continuously obtain event data, generate or update user device traffic maps, and optimize cell coverage within the wireless network.

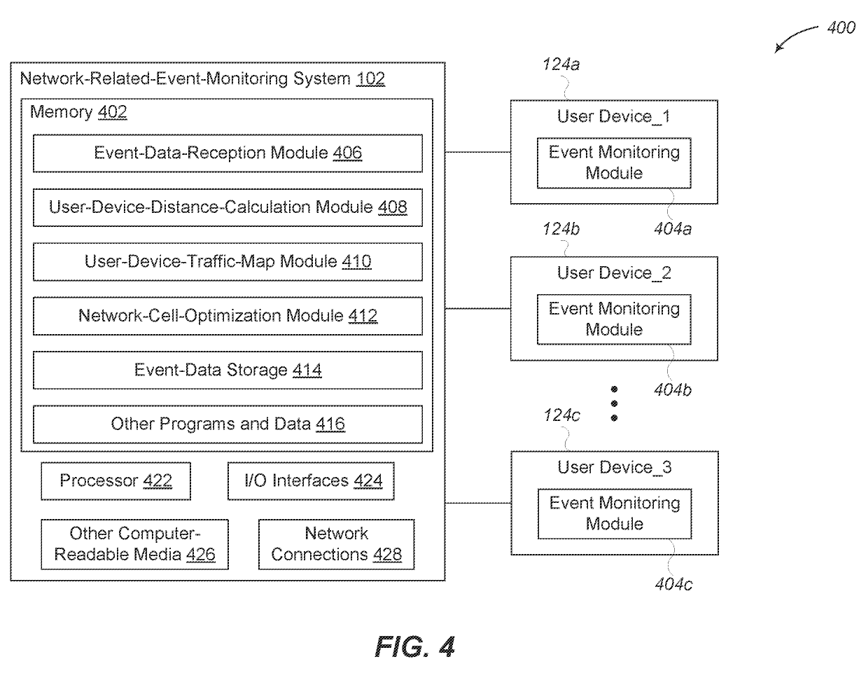

FIG. 4 shows a system diagram that describe various implementations of computing systems 600 for implementing embodiments described herein. Systems 600 includes a network-related-event-monitoring system 102 and user devices 124a-124c, similar to what is illustrated in FIG. 1.

The network-related-event-monitoring system 102 is a computing system or environment that obtains, receives, or collects network-related event data from user devices 124a-124c that are using the wireless network, and dynamically generates one or more user device traffic maps from the event data so that the wireless network can be optimized, as described herein. One or more special-purpose computing systems may be used to implement the network-related-event-monitoring system 102. Accordingly, various embodiments described herein may be implemented in software, hardware, firmware, or in some combination thereof. The network-related-event-monitoring system 102 includes memory 402, processor 422, I/O interfaces 424, other computer-readable media 426, and network connections 428.

Processor 422 includes one or more processors, one or more processing units, programmable logic, circuitry, or one or more other computing components that are configured to perform embodiments described herein or to execute computer instructions to perform embodiments described herein. In some embodiments, a processor system of the network-related-event-monitoring system 102 may include a single processor 422 that operates individually to perform actions. In other embodiments, a processor system of the network-related-event-monitoring system 102 may include a plurality of processors 422 that operate to collectively perform actions, such that one or more processors 422 may operate to perform some, but not all, of such actions. Reference herein to “a processor system” of the network-related-event-monitoring system 102 refers to one or more processors 422 that individually or collectively perform actions. And reference herein to “the processor system” of the network-related-event-monitoring system 102 refers to 1) a subset or all of the one or more processors 422 comprised by “a processor system” of the network-related-event-monitoring system 102 and 2) any combination of the one or more processors 422 comprised by “a processor system” of the network-related-event-monitoring system 102 and one or more other processors 422.

Memory 402 may include one or more various types of non-volatile and/or volatile storage technologies. Examples of memory 402 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 402 may be utilized to store information, including computer-readable instructions that are utilized by processor 422 to perform actions, including embodiments described herein.

Memory 402 may have stored thereon event-data-reception module 406, user-device-distance-calculation module 408, user-device-traffic-map module 410, and network-cell-optimization module 412. The event-data-reception module 406 is configured to communicate with the user devices 124a-124c to obtain event data that is captured and stored by the user devices, as described herein. The user-device-distance-calculation module 408 is configured to determine the distance between the user devices and the cells in which those user devices are communicating when a network-related event occurs, as described herein. The user-device-traffic-map module 410 is configured to generate one or more user device traffic maps from the network-related event data and the determined distances between the user devices and the cells for one or more specific network-related events, as described herein. The network-cell-optimization module 412 is configured to output the user device traffic maps to administrators of the wireless network or to automatically optimize or recommend optimizations to the wireless network, as described herein.

Although the event-data-reception module 406, the user-device-distance-calculation module 408, the user-device-traffic-map module 410, and the network-cell-optimization module 412 are illustrated as separate modules or components of the network-related-event-monitoring system 102, embodiments are not so limited. Rather one module or component, or a plurality of modules or components, may be utilized to implement the functionality of the event-data-reception module 406, the user-device-distance-calculation module 408, the user-device-traffic-map module 410, and the network-cell-optimization module 412.

Memory 402 may also store event-data storage 414 and other programs and data 416. The event-data storage 414 may be a database of network-related event data that is received from the user device 124a-124c. The other programs and data 416 may include operating systems, user device data, user device traffic maps, etc.

Network connections 428 are configured to communicate with other computing devices, such as user devices 124a-124c. In various embodiments, the network connections 428 include transmitters and receivers (not illustrated) to send and receive data as described herein. I/O interfaces 424 may include one or more data input or output interfaces, video or display interfaces, or other input/output interfaces. Other computer-readable media 426 may include other types of stationary or removable computer-readable media, such as removable flash drives, external hard drives, or the like.

The user devices 124a-124c may include computing components similar to the network-related-event-monitoring system 102, but are not shown in FIG. 4 for ease of discussion. The user devices 124a-124c, however, also include event monitoring modules 404a-404c, respectively. The event monitoring modules 404a-404c may be stored in the memory of the respective user devices 124a-124c. Each monitoring module may be configured to monitor the user device’s interactions with respect to the wireless network, identify network-related events, and generate and store event data relative to those network-related events, as described herein. The monitoring modules can then provide the stored event data to the network-related-event-monitoring system 102.

Although not illustrated, each user device 124a-124c may include a processor similar to processor 422. Accordingly, in some embodiments, a processor system of a user device 124 may include a single processor that operates individually to perform actions. In other embodiments, a processor system of the user device 124 may include a plurality of processors that operate to collectively perform actions, such that one or more processors may operate to perform some, but not all, of such actions. Reference herein to “a processor system” of the user device 124 refers to one or more processors that individually or collectively perform actions. And reference herein to “the processor system” of the user device 124 refers to 1) a subset or all of the one or more processors comprised by “a processor system” of the user device 124 and 2) any combination of the one or more processors comprised by “a processor system” of the user device 124 and one or more other processors.

The following is a summarization of the claims as originally filed.

A system may be summarized as comprising: a plurality of user devices and a network computing device. Each corresponding user device may include: a first memory that stores first computer instructions; and a first processor system that executes the first computer instructions to: monitor interactions between the corresponding user device and a wireless network, including: receive indications of each corresponding network-related event that occurs between the corresponding user device and the wireless network; for each corresponding network-related event: determine a cell of the wireless network in which the corresponding user device is communicating for the corresponding network-related event; and store event data regarding the corresponding network-related event and the determined cell. The network computing device may include: a second memory that stores second computer instructions; and a second processor system that executes the second computer instructions to: receive the stored event data from the plurality of user devices; determine a distance between each user device of the plurality of devices and the cells based on the received event data; generate a user device traffic map for a target area of the wireless network based on the determined distances between the plurality of user devices and the cells; and optimize cell coverage in the target area based on the user device traffic map.

The first processor system of each corresponding user device may receive indications of each corresponding network-related event by executing the first computer instructions to: receive an indication of a call to use the wireless network being initiated from the corresponding user device.

The first processor system of each corresponding user device may receive indications of each corresponding network-related event by executing the first computer instructions to: receive an indication of a call through the wireless network being drop.

The first processor system of each corresponding user device may receive indications of each corresponding network-related event by executing the first computer instructions to: receive an indication of a request to send data through the wireless network.

The first processor system of each corresponding user device may receive indications of each corresponding network-related event by executing the first computer instructions to: receive an indication of a request to receive data through the wireless network.

The first processor system of each corresponding user device may store event data regarding the corresponding network-related event by executing the first computer instructions to: store an event type associated with the corresponding network-related event with the event data.

The first processor system of each corresponding user device may store event data regarding the corresponding network-related event by executing the first computer instructions to: determine a geographical location of the corresponding user device at a time of the corresponding network-related event; and store the geographical location of the corresponding user device with the event data.

The first processor system of each corresponding user device may store event data regarding the corresponding network-related event by executing the first computer instructions to: determine a signal level or signal quality between the corresponding user device and the determined cell at a time of the corresponding network-related event; and store the signal level or signal quality with the event data.

The first processor system of each corresponding user device may store event data regarding the corresponding network-related event by executing the first computer instructions to: store an identifier of the determined cell with the event data.

A method may be summarized as comprising: receiving event data from a plurality of user devices for network-related events that have occurred while communicating will cells of a wireless network in a target area; determining a distance between each user device of the plurality of devices and the cells in the target area for each network-related event based on the event data; generating a user device traffic map for the target area based on the determined distances between the plurality of user devices and the cells in the target area; and optimizing cell coverage in the target area based on the user device traffic map.

The method may further comprise: sending a request to each corresponding user device of the plurality of user devices for the event data stored by each corresponding user device.

The method may receive the event data from the plurality of user devices including: receiving indications of calls to use the wireless network being initiated by each corresponding user device of the plurality of user devices.

The method may receive the event data from the plurality of user devices including: receiving indications of calls through the wireless network being dropped.

The method may receive the event data from the plurality of user devices including: receiving indications of requests made by each corresponding user device to send data through the wireless network.

The method may receive the event data from the plurality of user devices including: receiving indications of requests made by each corresponding user device to receive data through the wireless network.

The method may receive the event data from the plurality of user devices including: receiving an event type associated with each network-related event.

The method may receive the event data from the plurality of user devices including: receiving geographical locations of each corresponding user device for each network-related event.

The method may receive the event data from the plurality of user devices including: receiving signal levels or signal qualities between each corresponding user device and each corresponding cell during each corresponding network-related event.

The method may receive the event data from the plurality of user devices including: receiving identifiers of each corresponding cell in which each corresponding user device is communicating during each corresponding network-related event.

A non-transitory computer-readable medium may include storing computer instructions that, when executed by at least one processor, cause the at least one processor to perform actions, the actions comprising: receiving event data from a plurality of user devices for network-related events that have occurred while communicating will cells of a wireless network in a target area; determining a distance between each user device of the plurality of devices and the cells in the target area for each network-related event based on the event data; generating a user device traffic map for the target area based on the determined distances between the plurality of user devices and the cells in the target area; and optimizing cell coverage in the target area based on the user device traffic map, including at least one of: identifying a location in which to add a new cell to the wireless network; selecting a change in a tilt of an antenna of at least one cell in the target area; or selecting a change in a transmission power of an antenna of at least one cell in the target area.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a plurality of user devices, wherein each corresponding user device includes:
a first memory that stores first computer instructions; and
a first processor system that executes the first computer instructions to:
monitor interactions between the corresponding user device and a wireless network, including:
receive indications of each corresponding network-related event that occurs between the corresponding user device and the wireless network; and
for each corresponding network-related event:
determine a cell of the wireless network in which the corresponding user device is communicating for the corresponding network-related event; and
store event data regarding the corresponding network-related event and the determined cell; and
a network computing device that includes:
a second memory that stores second computer instructions; and
a second processor system that executes the second computer instructions to:
receive the stored event data from the plurality of user devices;
determine a distance between each user device of the plurality of devices and the cells based on the received event data;
generate a user device traffic map for a target area of the wireless network based on the determined distances between the plurality of user devices and the cells; and
optimize cell coverage in the target area based on the user device traffic map.

2. The system of claim 1, wherein the first processor system of each corresponding user device receives indications of each corresponding network-related event by executing the first computer instructions to:
receive an indication of a call to use the wireless network being initiated from the corresponding user device.

3. The system of claim 1, wherein the first processor system of each corresponding user device receives indications of each corresponding network-related event by executing the first computer instructions to:
receive an indication of a call through the wireless network being drop.

4. The system of claim 1, wherein the first processor system of each corresponding user device receives indications of each corresponding network-related event by executing the first computer instructions to:
receive an indication of a request to send data through the wireless network.

5. The system of claim 1, wherein the first processor system of each corresponding user device receives indications of each corresponding network-related event by executing the first computer instructions to:
receive an indication of a request to receive data through the wireless network.

6. The system of claim 1, wherein the first processor system of each corresponding user device stores event data regarding the corresponding network-related event by executing the first computer instructions to:
store an event type associated with the corresponding network-related event with the event data.

7. The system of claim 1, wherein the first processor system of each corresponding user device stores event data regarding the corresponding network-related event by executing the first computer instructions to:
determine a geographical location of the corresponding user device at a time of the corresponding network-related event; and
store the geographical location of the corresponding user device with the event data.

8. The system of claim 1, wherein the first processor system of each corresponding user device stores event data regarding the corresponding network-related event by executing the first computer instructions to:
determine a signal level or signal quality between the corresponding user device and the determined cell at a time of the corresponding network-related event; and
store the signal level or signal quality with the event data.

9. The system of claim 1, wherein the first processor system of each corresponding user device stores event data regarding the corresponding network-related event by executing the first computer instructions to:
store an identifier of the determined cell with the event data.

10. A method, comprising:
receiving event data from a plurality of user devices for network-related events that have occurred while communicating will cells of a wireless network in a target area;
determining a distance between each user device of the plurality of devices and the cells in the target area for each network-related event based on the event data;
generating a user device traffic map for the target area based on the determined distances between the plurality of user devices and the cells in the target area; and
optimizing cell coverage in the target area based on the user device traffic map.

11. The method of claim 10, further comprising:
sending a request to each corresponding user device of the plurality of user devices for the event data stored by each corresponding user device.

12. The method of claim 10, wherein receiving the event data from the plurality of user devices includes:
receiving indications of calls to use the wireless network being initiated by each corresponding user device of the plurality of user devices.

13. The method of claim 10, wherein receiving the event data from the plurality of user devices includes:
receiving indications of calls through the wireless network being dropped.

14. The method of claim 10, wherein receiving the event data from the plurality of user devices includes:
receiving indications of requests made by each corresponding user device to send data through the wireless network.

15. The method of claim 10, wherein receiving the event data from the plurality of user devices includes:
receiving indications of requests made by each corresponding user device to receive data through the wireless network.

16. The method of claim 10, wherein receiving the event data from the plurality of user devices includes:
receiving an event type associated with each network-related event.

17. The method of claim 10, wherein receiving the event data from the plurality of user devices includes:
receiving geographical locations of each corresponding user device for each network-related event.

18. The method of claim 10, wherein receiving the event data from the plurality of user devices includes:
receiving signal levels or signal qualities between each corresponding user device and each corresponding cell during each corresponding network-related event.

19. The method of claim 10, wherein receiving the event data from the plurality of user devices includes:
receiving identifiers of each corresponding cell in which each corresponding user device is communicating during each corresponding network-related event.

20. A non-transitory computer-readable medium storing computer instructions that, when executed by at least one processor, cause the at least one processor to perform actions, the actions comprising:
receiving event data from a plurality of user devices for network-related events that have occurred while communicating will cells of a wireless network in a target area;
determining a distance between each user device of the plurality of devices and the cells in the target area for each network-related event based on the event data;
generating a user device traffic map for the target area based on the determined distances between the plurality of user devices and the cells in the target area; and
optimizing cell coverage in the target area based on the user device traffic map, including at least one of:
identifying a location in which to add a new cell to the wireless network;
selecting a change in a tilt of an antenna of at least one cell in the target area; or
selecting a change in a transmission power of an antenna of at least one cell in the target area.
